(19) United States
(12) Patent Application Publication
(10) Pub. No.: US 2012/0132792 A1
(43) Pub. Date: May 31, 2012

(54) OPTICAL MODULE COMPRISING OPTICAL HYBRID USING METAL OPTICAL WAVEGUIDE AND PHOTO DETECTOR

(75) Inventors: Joong-Seon Choe, Daejeon (KR); Jong-Hoi Kim, Daejeon (KR); Chun Ju Youn, Daejeon (KR); Duk Jun Kim, Daejeon (KR); Kwang-Seong Choi, Daejeon (KR); Yong-Hwan Kwon, Daejeon (KR); Eun Soo Nam, Daejeon (KR)

(73) Assignee: ELECTRONICS AND TELECOMMUNICATIONS RESEARCH INSTITUTE, Daejeon (KR)

(21) Appl. No.: 13/278,196

(22) Filed: Oct. 21, 2011

(30) Foreign Application Priority Data
Nov. 25, 2010 (KR) 10-2010-0117931

(51) Int. Cl. H01J 40/14

(52) U.S. Cl. 250/216

(57) ABSTRACT

An exemplary embodiment of the present disclosure provides an optical module including: an optical hybrid including a metal optical waveguide; a photo detector configured to receive light; and a platform including an optical hybrid supporting section for supporting the optical hybrid, a photo detector supporting section for supporting the photo detector, and an inclined surface configured to change a propagation direction of light emitted from the optical hybrid, and configured to combine the optical hybrid and the photo detector.

### CROSS-REFERENCE TO RELATED APPLICATIONS

This application is based on and claims priority from Korean Patent Application No. 10-2010-0117931, filed on Nov. 25, 2010, with the Korean Intellectual Property Office, The present disclosure of which is incorporated herein in its entirety by reference.

### TECHNICAL FIELD

The present disclosure relates to an optical module in which an optical hybrid and a photo detector are combined in an optical communication system. More particularly, the present disclosure relates to an optical module including an optical hybrid using a metal optical waveguide, an incidence type photo detector, and a platform configured to combine the optical hybrid and the photo detector.

### BACKGROUND

From among optical components for coherent optical communication, an optical hybrid, a photo detector, and a coherent light receiver integrated with an amplifier are core components for converting phase shift keying signals of two channels into electrical signals. The optical hybrids used for them are generally formed by using silica optical waveguide or disposing mirrors, an optical splitter, and the like in a free space. The photo detector is generally manufactured by using semiconductor substances grown on a semiconductor substrate, particularly, an indium phosphide (InP) substrate, and is not made on the same substrate with the optical hybrid. Therefore, the photo detector operates by connecting output light of the optical hybrid to an input terminal of the photo detector. When the optical hybrid and the photo detector made of different substances as described above are coupled, a loss of light occurs. For this reason, in order to manufacture a module having good characteristics, it is necessary to minimize the loss of light. In this case, for effective optical connection, the configuration of the photo detector is specially designed or a method of applying an input to the photo detector by using optical components, such as a lens or a mirror, between the optical hybrid and the photo detector is used. For example, in order to change a direction of light, an optical mirror may be used, and in order to condense light to a small condensing area of the photo detector, an optical component such as an optical lens may be used. If those optical components are used, an assembling process is complicated, the cost increases, and a manufacturing yield is also reduced.

A passive optical waveguide can be made of various substances. Commonly used substances are silica, polymer, semiconductor, and the like, and the optical waveguide is configured in a form in which a high-refractive-index portion (core) is surrounded by a low-refractive-index substance (cladding or clad). Light moves along the core, and whether the optical waveguide is a single mode or a multiple mode is determined according to the size and refractive index of the core, a difference in the refractive index between the cladding and the core, and the wavelength of the guided light. In general, as the size of the core increases, the difference in refractive index between the core and the cladding increases, or the wavelength of the light decreases, the number of waveguide modes increases. Therefore, in a general optical waveguide, in order to implement a single mode, a core having a width and thickness of several nm or less is used. In this case, when light is output from the optical waveguide into the air, a light spreading phenomenon occurs. For this reason, optical hybrids using existing optical waveguides to cope with the light spreading phenomenon generally use additional optical systems for connecting with a photo detector.

General optical waveguides transmit light by using a total internal reflection characteristic of light. Here, the total internal reflection means a phenomenon in which, when light from a high-refractive-index substance is incident to a low-refractive-index substance, in a case where the incidence angle of the light is a predetermined threshold angle or greater, the light is totally reflected without being refracted.

Since the general optical waveguides use the total internal reflection characteristic of light for optical signal transmission, the size is limited by a limit of diffraction of light. That is, the general optical waveguides can validly transmit an optical signal when the size is larger than the wavelength of the optical signal, and cannot validly transmit the optical signal when the size is equal to or smaller than the limit of diffraction of light. For this reason, in order to validly transmit an optical signal having a wavelength equal to or smaller than the limit of diffraction of light, there has been proposed an optical waveguide (hereinafter, referred to as ‘surface plasmon optical waveguide’) that transmits signals by using surface plasmon polaritons. Since a metal is a perfect conductor, an electric field cannot occur inside the metal by a signal in a microwave band.

### SUMMARY

The present disclosure has been made in an effort to provide a device and method for efficiently connecting output light of an optical hybrid to a photo detector without using additional optical components.

An exemplary embodiment of the present disclosure provides an optical module including: an optical hybrid including a metal optical waveguide; a photo detector configured to receive light; and a platform including an optical hybrid supporting section for supporting the optical hybrid, a photo detector supporting section for supporting the photo detector, and an inclined surface configured to change a propagation direction of light emitted from the optical hybrid, and configured to combine the optical hybrid and the photo detector. Here, the inclined surface of the platform may form 45 degrees to a plane of the optical hybrid supporting section.

The photo detector may include a photo detector substrate, and a light absorbing unit formed on at least a portion of the photo detector substrate. The photo detector substrate contains indium phosphide (InP) and the light absorbing unit contains indium gallium arsenide (InGaAs).

At least a portion of the photo detector substrate may be attached onto the photo detector supporting section of the platform, the light absorbing unit may be formed on the photo detector substrate to receive light reflected from the inclined surface of the platform, and the reflected light may be received by the photo detector through the photo detector substrate.

The optical module may further include an attached substrate on the photo detector supporting section, in which at least a portion of the photo detector substrate is attached onto the attached substrate, and the light absorbing unit is disposed to face the inclined surface of the platform to receive light reflected from the inclined surface of the platform. The platform may contain a metal. The optical module may further include a metal layer formed on the inclined surface of the platform. The metal optical waveguide may be a surface plasmon optical waveguide.

A distance between the optical hybrid and the photo detector may be controlled. The distance between the optical hybrid and the photo detector may be determined on the basis of a deviation of a height of an optical waveguide core of the optical hybrid.

According to the exemplary embodiments of the present disclosure, since the optical hybrid is manufactured by using the metal optical waveguide whose output light is spread less, optical connection between the optical hybrid and the surface incidence type photo detector is facilitated without using additional optical components.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A to 1F are cross-sectional views of a metal optical waveguide for explaining a process of forming the metal optical waveguide according to an exemplary embodiment of the present disclosure.

FIG. 2 is a view illustrating an optical hybrid module including the metal optical waveguide according to an exemplary embodiment of the present disclosure.

FIG. 3 is a view illustrating an optical module structure in which an optical hybrid and a surface incidence type photo detector are coupled according to an exemplary embodiment of the present disclosure.

FIG. 4 is a conceptual view for explaining a method of controlling a distance between the optical hybrid and the photo detector according to an exemplary embodiment of the present disclosure.

FIG. 5 is a view illustrating an optical module structure in which an optical hybrid and a surface incidence type photo detector are coupled according to another exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described with reference to the accompanying drawings in detail such that those skilled in the art can easily carry out the technical scope of the present disclosure.

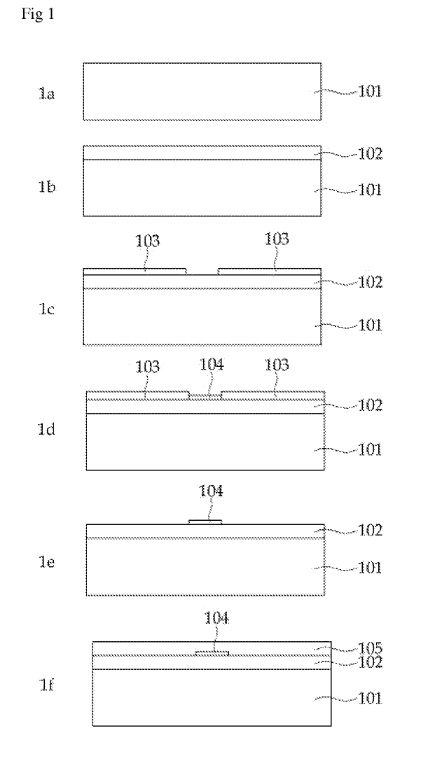

FIGS. 1A to 1F are cross-sectional views of a metal optical waveguide for explaining a process of forming the metal optical waveguide according to an exemplary embodiment of the present disclosure.

Referring to FIG. 1A, a substrate 101 is first formed. The substrate contains a semiconductor such as sapphire, quartz, glass, and silicon.

Referring to FIG. 1B, a lower cladding 102 is formed on the substrate. Next, a photolithographic process is performed to form a predetermined metal pattern for forming a metal optical waveguide. For example, an exposure process using a mask on lower cladding 102 may be performed. Referring to FIG. 1C, as a result of the photolithographic process, photo resists 103 are formed on lower cladding 102.

Next, in order to form the metal optical waveguide, a metal line 104 is thinly deposited on lower cladding 102. As shown in FIG. 1D, metal line 104 is thinly deposited in a pattern between photo resists 103 on lower cladding 102. For example, the thickness of metal line 104 may be about 1 nm to 100 nm, or 5 nm to 20 nm

Next, photo resists 103 formed on lower cladding 102 are removed through a lift-off process. As shown in FIG. 1E, on the lower cladding 102, only metal line 104 formed in the pattern for forming a core of the metal optical waveguide remains.

Next, as shown in FIG. 1F, an upper cladding 105 is formed on lower cladding 102 and metal line 104 such that metal line 104 is interposed between lower cladding 102 and upper cladding 105.

Lower cladding 102 and upper cladding 105 may contain a polymer substance with less loss of light or contain another dielectric substance such as silica. Also, lower cladding 102 and upper cladding 105 may be formed of one layer as shown in FIG. 1E, or may be formed of a plurality of layers made of a plurality of different substances.

If light is put into the metal line formed as described above, surface plasmon polaritons are generated at the interface between the claddings containing a dielectric substance such as polymer or silica and metal line 104 formed between the claddings, and such an optical waveguide is called a surface plasmon optical waveguide.

The surface plasmon optical waveguide can be formed by a simple process such as photolithography as described above, and has considerably less transmission loss of light, and has a single mode large in size such that when light goes out of the optical waveguide through a cut surface, the light rarely spreads.

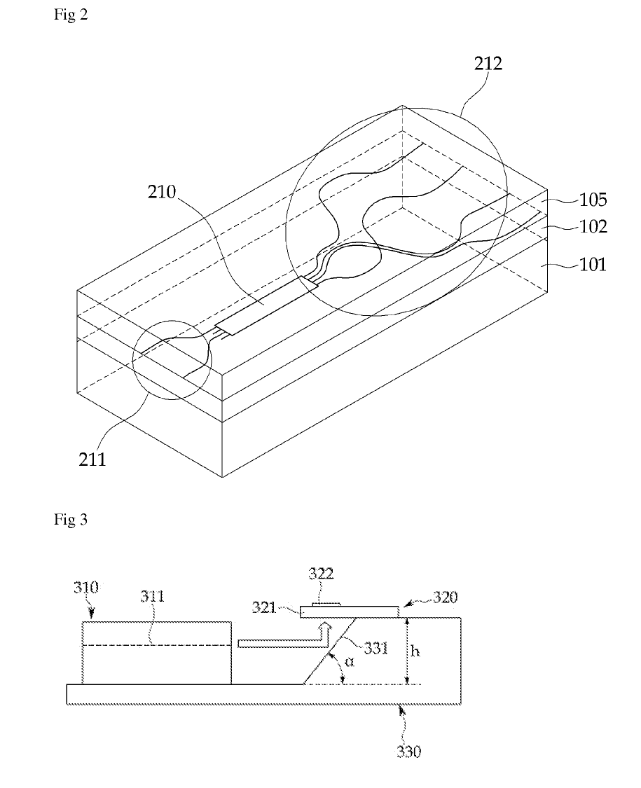

FIG. 2 is a view illustrating an optical hybrid module including the metal optical waveguide according to an exemplary embodiment of the present disclosure.

The optical hybrid of FIG. 2 may be manufactured through the process of forming the metal optical waveguide shown in FIGS. 1A to 1F.

Referring to FIG. 2, a metal optical waveguide core 210 is interposed between upper cladding 105 and lower cladding 102 on substrate 101. Metal optical waveguide core 210 of FIG. 2 is an optical hybrid for QPSK, has an input terminal 211 with two inputs and an output terminal 212 with four outputs, and is formed of a multimode interferometer (MMI). The optical hybrid may be formed of one MMI as shown in FIG. 2, or may be formed of two or more MMIs. The optical hybrid acts such that when two input beams are mixed and output to four output terminals, predetermined phase differences occur among the output terminals. As described above, the MMI optical hybrid including the metal optical waveguide may be manufactured in the same form as an MMI optical hybrid based on a semiconductor or silica.

FIG. 3 is a view illustrating an optical module structure in which an optical hybrid and a surface incidence type photo detector are coupled according to an exemplary embodiment of the present disclosure. Referring to FIG. 3, the optical module structure includes an optical hybrid 310, a surface incidence type photo detector 320, and a platform 330 coupling optical hybrid 310 and the surface incidence type photo detector 320.

A light output of optical hybrid 310 through a metal optical waveguide core 311 propagates in a direction parallel to a bottom surface of platform 330. However, since a layout in which surface incidence type photo detector 320 is disposed in a direction vertical to the bottom surface of platform 330 to receive light is disadvantageous in the alignment and assembly processes, surface incidence type photo detector 320 may be attached to a top surface of platform 330. For this, in platform 330 for coupling optical hybrid 310 and photo detector 320, a gap h is formed between a top portion of the platform supporting optical hybrid 310 and a top portion of the platform supporting photo detector 320, and the portion formed due to gap h is polished to have an inclined surface 331, not a vertical surface.

The propagation direction of the light output through metal optical waveguide core 311 is changed to a direction vertical to the bottom surface of platform 330 at inclined surface 331 of platform 330. At this time, inclined surface 331 of platform 330 acts as a light reflector. Platform 330 may be made of a semiconductor such as sapphire, quartz, glass, and silicon, or a metal material. Also, a metal layer may be formed on inclined surface 331 of platform 330 to induce efficient light reflection.

An inclination angle α formed between inclined surface 331 and a plane parallel to the bottom surface of platform 330 may be set to about 45 degrees. In a case where inclined surface 331 of platform 330 forms the inclination angle of 45 degrees, the incidence angle and reflection angle of the light output through metal optical waveguide core 311 become 45 degrees due to the law of reflection of light. Therefore, the propagation direction of the light is changed at inclined surface 331 by 90 degrees such that the light propagates in a direction accurately vertical to the bottom surface of platform 330. As described above, since inclined surface 331 formed due to gap h of platform 330 is used as a reflector, in order to change the propagation direction of the light in a direction toward photo detector 320 coupled with the top portion of platform 330, it is unnecessary to use any other optical component such as a 45-degree mirror.

Photo detector 320 is a device that receives an optical signal and converts the optical signal into an electrical signal by using an internal photoelectric effect. For example, photo detector 320 may be formed of a diode type photo detection element such as a PN junction photo diode, a positive intrinsic negative (PIN) photo diode, and an avalanche photo diode (APD).

Photo detector 320 includes a photo detector substrate 321 and a light absorbing unit 332 formed on photo detector substrate 321. As shown in FIG. 3, a portion of photo detector substrate 321 of photo detector 320 is coupled with a right top surface of platform 330, and light absorbing unit 332 is disposed on photo detector substrate 321 to be positioned at a portion of photo detector substrate 321 that is not coupled with the top surface of platform 330, that is, over inclined surface 331 of platform 330. The light output reflected toward photo detector 320 enters light absorbing unit 332 through photo detector substrate 321. For example, photo detector substrate 321 may contain indium phosphide (InP) and light absorbing unit 332 may contain indium gallium arsenide (InGaAs).

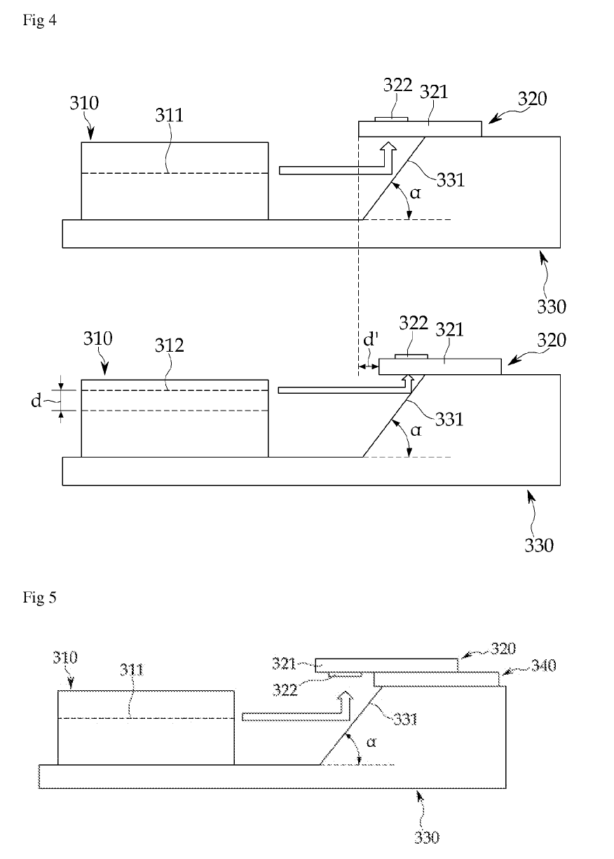

FIG. 4 is a conceptual view for explaining a method of controlling a distance between the optical hybrid and the photo detector according to an exemplary embodiment of the present disclosure. FIG. 4 shows the method of controlling the distance between the photo detector and the optical hybrid to compensate for a height deviation of the core of the optical waveguide constituting the optical hybrid.

In a case of forming the metal optical waveguide, the height of the optical waveguide core is the sum of the thickness of the substrate and the thickness of the lower cladding. However, since it is not easy to adjust the height of the optical waveguide core to a constant value in every process, it is inevitable that a deviation of minimum several nm to several tens nm occurs. Referring to FIG. 4, the height of core 311 of the optical waveguide in an optical module device shown in the upper portion of FIG. 4 differs from the height of core 312 of the optical waveguide in an optical module device shown in the lower portion of FIG. 4 by d. The deviation of the heights of the optical waveguide cores can be compensated for by adjusting the distance between the photo detector and the optical hybrid by d′. For example, in a case where inclination angle α of inclined surface 331 of platform 330 is 45 degrees, if the distance between photo detector 320 and optical hybrid 310 is adjusted to the same distance (d′=d) as deviation d between cores 311 and 312 of the optical waveguides, the light output from optical hybrid 310 can exactly enter light absorbing unit 332 of photo detector 320 by reflecting at inclined surface 331. Therefore, according to the optical module device, the deviation of the heights of the optical waveguide cores occurring in the manufacture process can be solved by controlling the distance between optical hybrid 310 and photo detector 320.

FIG. 5 is a view illustrating an optical module structure in which an optical hybrid and a surface incidence type photo detector are coupled according to another exemplary embodiment of the present disclosure. Referring to FIG. 5, the optical module structure includes optical hybrid 310, surface incidence type photo detector 320, platform 330, and an attached substrate 340 for attaching surface incidence type photo detector 320 to platform 330.

Light absorbing unit 332 of photo detector 320 of FIG. 5 is disposed such that the light output directly enters light absorbing unit 332 without passing through photo detector substrate 321, unlike the case shown in FIG. 3. In order to dispose light absorbing unit 332 of photo detector 320 to face inclined surface 331 of platform 330, attached substrate 340 is provided such that inverted photo detector 320 is attached to the right top surface of platform 330. Attached substrate 340 may be a ceramic substrate or a PCB substrate.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An optical module, comprising:
an optical hybrid including a metal optical waveguide;
a photo detector configured to receive light; and
a platform including an optical hybrid supporting section for supporting the optical hybrid, a photo detector supporting section for supporting the photo detector, and an inclined surface configured to change a propagation direction of light emitted from the optical hybrid, and configured to combine the optical hybrid and the photo detector.

2. The optical module of claim 1, wherein the inclined surface of the platform forms 45 degrees to a plane of the optical hybrid supporting section.

3. The optical module of claim 1, wherein the photo detector includes a photo detector substrate, and a light absorbing unit formed on at least a portion of the photo detector substrate.

4. The optical module of claim 3, wherein the photo detector substrate contains indium phosphide (InP) and the light absorbing unit contains indium gallium arsenide (InGaAs).

5. The optical module of claim 3, wherein at least a portion of the photo detector substrate is attached onto the photo detector supporting section of the platform, the light absorbing unit is formed on the photo detector substrate to receive light reflected from the inclined surface of the platform, and the reflected light is received by the photo detector through the photo detector substrate.

6. The optical module of claim 3, further comprising:
an attached substrate on the photo detector supporting section,
wherein at least a portion of the photo detector substrate is attached onto the attached substrate, and the light absorbing unit is disposed to face the inclined surface of the platform to receive light reflected from the inclined surface of the platform.

7. The optical module of claim 1, wherein the platform contains a metal.

8. The optical module of claim 1, further comprising:
a metal layer formed on the inclined surface of the platform.

9. The optical module of claim 1, wherein the metal optical waveguide is a surface plasmon optical waveguide.

10. The optical module of claim 1, wherein a distance between the optical hybrid and the photo detector is controlled.

11. The optical module of claim 10, wherein the distance between the optical hybrid and the photo detector is determined on the basis of a deviation of a height of an optical waveguide core of the optical hybrid.
